(19) United States
(12) Patent Application Publication
(10) Pub. No.: US 2002/0194983 A1
(43) Pub. Date: Dec. 26, 2002

(54) Web-enabled software guitar tablature and method therefore

(76) Inventor: Christopher Mark Tanner, Crystal City, VA (US)

Correspondence Address: Chris Tanner, Esq., 1201 S. Eads St., #1811, Crystal City, VA, 22202-2845, US

(21) Appl. No.: 09/887,340

(22) Filed: Jun. 25, 2001

(51) Int. Cl. G09B 15/02

(52) U.S. Cl. 84/478

(57) ABSTRACT

A software implementation of guitar tablature is disclosed. The invention can be implemented using any computer text editor, and can incorporate lyrics therein. The files created therefrom are small, easily transportable even between dissimilar computers, and rendered into .html without difficulty.

### FIELD OF THE INVENTION

The present invention relates to the field of guitar tablature. Specifically, the present invention allows for the entering and editing of guitar tablature into a common, easily maintainable format that is not specific to a single computer. The files created using the present invention can be easily transported between various computers, and can be rendered into .html without difficulty.

### BACKGROUND OF THE INVENTION

The use of tablature for representing chord positions on a guitar is well-known. However, when entering guitar tablature, during either transposing or composing music, a guitarist may hand-write the chord patterns on paper. The paper may be either blank or have pre-printed tablature template patterns symbolizing the neck of a guitar. In either case, significant effort is expended by the user in hand-writing. Additionally, editing and/or copying the finished patterns can be difficult and may require laborious hand-copying or the use of a photocopier. Thus, a need exists to reduce some of the labor associated with transcribing/composing compositions.

Fortunately, many guitarists also have personal computers, or access to computers of some type. Accordingly, numerous music transcription computer software products which can assist in the musical transcription/composition process are commercially available. These include Musedit, made by Yowsa software (Yowza Software, P.O. Box 4275, Berkeley Calif. 94704; musedit.com), which specializes in translating back and forth between guitar tablature and standard treble/bass clef music notation. Another is Cakewalk, made by Cakewalk (Cakewalk, 51 Melcher St, Boston, Mass. 02210-1508; cakewalk.com), which allows for the user to play music on either a guitar (equipped with a MIDI interface) or a keyboard and have that music automatically transcribed into standard treble/bass clef music notation. However, Cakewalk does not make any provision for guitar tablature. Additionally, computer files created using either of these programs cannot be read or edited by another user unless that other user also has a legally purchased, properly licensed version of the same software. Other systems for using a computer to represent guitar tablature are disclosed in the following U.S. Patents: U.S. Pat. Nos. 4,384,503; 6,201,174; and 6,166,313.

As stated, some of the above systems require proprietary application software to edit, read, save, interpret, and exchange the music files created therewith. Additionally, the file formats for the above software applications are non-standardized and likely to be completely incompatible with each other. Finally, none of the above references resolve difficulties which occur when attempting to incorporate the guitar tablature representations created therein into the World Wide Web.

The present invention solves these and other problems by allowing for the guitar tablature to be entered, saved, read, edited, uploaded, downloaded, and exchanged on virtually any type of computer.

### SUMMARY OF THE INVENTION

It is an object of the present invention to meet the above-described needs and others. Specifically, it is an object of the present invention to provide a software implementation of guitar tablature, including a horizontal row of equal sign ‘=’ characters representing a nut of a guitar; a first group of six vertical bar ‘|’ characters located directly underneath said horizontal row of equal sign ‘=’ characters, representing the six strings of a guitar; a first horizontal row of dash ‘-’ characters located directly underneath said first group of six vertical bar ‘|’ characters representing a first fret of a guitar, so that the first group of vertical bar characters then represent a first fretboard position on guitar; a second group of six vertical bar ‘|’ characters located directly underneath the first horizontal row of dash ‘-’ characters, thereby representing a further extension of said six strings of a guitar; a second horizontal row of dash ‘-’ characters representing a second fret of a guitar and located directly underneath the second group of six vertical bar ‘|’ characters, so that the second group of six vertical bar characters then represent a second fretboard position on guitar;

a third group of six vertical bar ‘|’ characters located directly underneath the second horizontal row of dash ‘-’ characters, thereby representing a further extension of the six strings of a guitar;

a third horizontal row of dash ‘-’ characters representing a third fret of a guitar and located directly underneath the third group of six vertical bar ‘|’ characters, so that the third group of six vertical bar characters then represent a third fretboard position on guitar;

a fourth group of six vertical bar ‘|’ characters located directly underneath the horizontal row of dash ‘-’ characters, thereby again representing a further extension of the six strings of a guitar;

a fourth horizontal row of dash ‘-’ characters representing a fourth fret of a guitar and located directly underneath the third group of six vertical bar ‘|’ characters, so that the fourth group of six vertical bar characters then represent a fourth fretboard position on guitar;

whereby predetermined of the vertical bar ‘|’ characters are replaced by either an ‘o’ (for nonspecific fingering) or ‘1’, ‘2’, ‘3’, ‘4’, or ‘T’, which correspond to the first, second, third, fourth fingers and thumb of the fretting hand according to a predetermined chord fingering; and further whereby an ‘o’ or ‘x’ is optionally positioned above the horizontal row of ‘=’ signs to signify whether to strike or not strike a particular string, thereby achieving a computerized representation of a guitar chord tablature in plain computer text which can be cut, pasted, and saved.

It is a further object of the present invention to provide a software implementation of guitar tablature that can be interspersed within the lyrics of a specific composition.

It is a further object of the present invention to provide a method for implementing guitar tablature in computer software, including:

positioning a horizontal row of equal sign ‘=’ characters in the top line of a text-only computer file; positioning a first group of six vertical bar ‘|’ characters directly underneath said horizontal row of equal sign ‘=’ characters; positioning a first horizontal row of dash ‘-’ characters directly underneath said first group of six vertical bar ‘|’ characters; positioning a second group of six vertical bar ‘|’ characters directly underneath said first horizontal row of dash ‘-’ characters; positioning a second horizontal row of dash ‘-’ characters directly underneath said second group of vertical bar ‘|’ characters; positioning a third group of six vertical bar ‘|’ characters directly underneath said second horizontal row of dash ‘-’ characters; positioning a third horizontal row of dash ‘-’ characters directly underneath said third group of vertical bar ‘|’ characters; positioning a fourth group of six vertical bar ‘|’ characters directly underneath said third horizontal row of dash ‘-’ characters; positioning a fourth horizontal row of dash ‘-’ characters directly underneath said fourth group of vertical bar ‘|’ characters; then replacing predetermined vertical bar ‘|’ characters with either an ‘o’ (for nonspecific fingering) or ‘1’, ‘2’, ‘3’, ‘4’, or ‘T’, which correspond to the first, second, third, fourth fingers and thumb of the fretting hand according to a predetermined chord fingering, optionally positioning an ‘o’ or ‘x’ above said horizontal row of ‘=’ signs to signify whether to strike or not strike a particular string, thereby achieving a representation of a predetermined guitar chord tablature in plain computer text which can be cut, pasted, and saved.

Finally, it is a further object of the present invention to method for implementing guitar tablature in computer software, including, prior to said step of positioning a horizontal row of equal sign ‘=’ characters, transcribing lyrics of a composition into computer text; then incorporating a plurality of the computer text guitar chord tablature representations within the lyrics of said composition.

Additional objects, advantages and novel features of the invention will be set forth in the description which follows or may be learned by those skilled in the art through reading these materials or practicing the invention. The objects and advantages of the invention may be achieved through the means recited in the attached claims. To achieve these stated and other objects, the present invention may be embodied and described as the ensuing description and accompanying drawings.

### BRIEF DESCRIPTION OF THE DRAWINGS

The accompanying drawings illustrate the present invention and are a part of the specification. Together with the following description, the drawings demonstrate and explain the principles of the present invention.

FIG. 1 is an unpopulated template for guitar tablature which is part of the present invention.

FIG. 2 shows the tablature template of FIG. 1, but specifically populated to represent an ‘E’ chord.

FIG. 3 shows the ‘E’ chord representation of FIG. 2, further modified to show a recommended finger of the fretting hand.

FIG. 4 shows how the guitar tablature of the present invention can be incorporated within, above, or below composition lyrics.

FIG. 5 shows an example of the software guitar tablature of the present invention incorporating a reminder note or brief message.

FIG. 6 shows an additional example of the software guitar tablature of the present invention incorporating a reminder note or brief message.

FIG. 7 shows the composition of FIG. 4, modified to take advantage of traditional lettered chord notation.

FIG. 8 shows a representation of an intermediate draft of a composition with the software guitar tablature of the present invention in a not fully populated state.

FIG. 9 shows several tablature blocks arranged horizontally, and the corresponding difficulty in selecting just one of those tablature blocks.

FIG. 10 shows an attempt to paste one of the tablature blocks into the arrangement of FIG. 9.

FIG. 11 shows an example of a text editor which supports the selecting/copying/cutting nonlinear blocks of text, including tablature blocks.

FIG. 12 shows the pasting of a tablature block so as to be horizontally adjacent another tablature block using the text editor of FIG. 11.

FIG. 13 shows Microsoft Word's a “spike” feature which support of the copying of non-sequential blocks of text.

FIGS. 14a-g show how the “spike” feature of FIG. 13 allows for the cutting/copying of a single block of tablature even when positioned within a horizontal group of tablature symbols, by cutting an individual tablature block line-by-line.

FIG. 15 shows the location of saving files in “text only” or “text with line breaks” within Microsoft Word.

FIG. 16 shows the composition of FIG. 4 modified to include .html tags.

FIG. 17 shows what the text of FIG. 16 would look like when viewed over the Internet through Microsoft Internet Explorer.

FIG. 18 shows how a remote user could highlight, copy, and download a text-only non-.html version of a composition uploaded using the present invention.

FIG. 19 shows how a user could paste the text of FIG. 18 into Microsoft Notepad.

### DETAILED DESCRIPTION OF THE PREFERRED EMBODIMENTS

Using the drawings, the preferred embodiments of the present invention will now be explained.

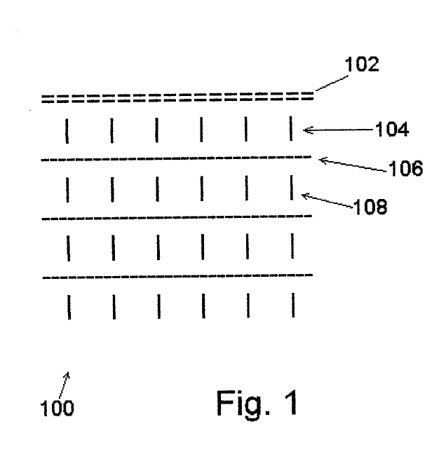

FIG. 1 depicts a template 100 for guitar tablature rendered into computer text characters, which is a feature of the present invention. For purposes of illustration, the template 100 is shown not yet populated with a particular chord pattern. As shown in FIG. 1, a horizontal row 102 of equal sign ‘=’ characters represents a nut (fret 0) of a guitar; while a first group 104 of six vertical bar ‘|’ characters located directly underneath said horizontal row of equal sign ‘=’ characters represents the six strings of a guitar. Additionally, a first horizontal row 106 of dash ‘-’ characters representing a first fret of a guitar, so that said first group of vertical bar characters then represent a first position on the neck of a guitar. A second group 108 of six vertical bar ‘|’ characters located directly underneath said first horizontal row 106 of dash ‘-’ characters, thereby representing a further extension of said six strings of a guitar, while a second group of horizontal row of dash ‘-’ characters representing a second fret of a guitar, so that said second group of six vertical bar characters then represent a second position on the neck of a guitar. For illustrative purposes, the present invention's tablature arrangement of FIG. 1 is repeated for the first four fretboard positions, although many chord patterns do not require four separate positions, while others require five.

The advantage of choosing the characters ‘=’, ‘|’, and ‘-’ is that these characters are found on all computer keyboards, whether Wintel, Macintosh, Unix, or some other architecture. Thus, the present invention works within any text editor on any computer, and no specialized software required to interpret the files created therefrom. Also, the text-only nature of the files means that their file size is relatively small, which means many of those files could fit on a single floppy disk. Additionally, the composition files created with the present invention could be exchanged or e-mailed between users at very high volume without significant constraints on computer disk space or network bandwidth.

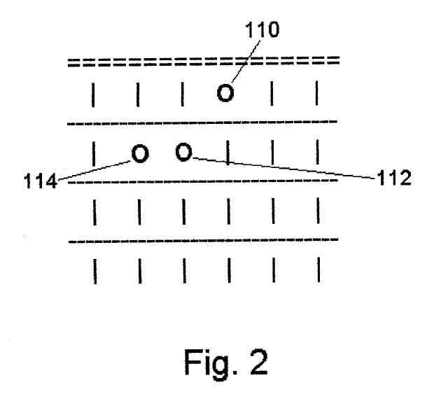

FIG. 2 shows the tablature template of FIG. 1 populated to represent an ‘E’ chord, chosen because it is commonly used and well-known among guitarists. The tablature representing the third string should be fretted at the first position 110, while the fourth and fifth strings should be fretted at their respective second positions 112, 114.

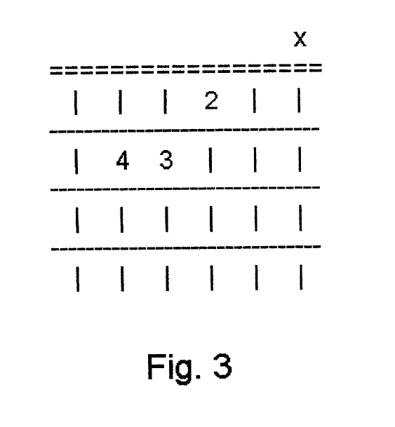

FIG. 3 shows the ‘E’ chord representation of FIG. 2, further modified to show the specific finger of the fretting hand that is recommended to properly finger the ‘E’ chord, either ‘1’, ‘2’, ‘3’, ‘4’, or ‘T’. The ‘x’ positioned above the horizontal row of ‘=’ signs represents a certain string which is meant to either be muted, or, if possible, not struck whatsoever. Furthermore, a numeral positioned to the left of the topmost fretboard position is intended to symbolize that that position be where the leftmost fingers are located. Such a feature is useful for chord positions which do not originate at the fretboard's first position. Many chords are positioned far down the right side of the fretboard (“high on the neck”), so that one or more of the lower fretboard positions are unused and hence not necessary to be represented in tablature. Below is a list of additional tablature notations that can be used in the present invention.

h—hammer on

p—pull off

b—bend string up

r—release bend

|—slide up

\—slide down

v—vibrato (sometimes written as ˜)

t—tap (with strumming hand)

x—muted, struck string

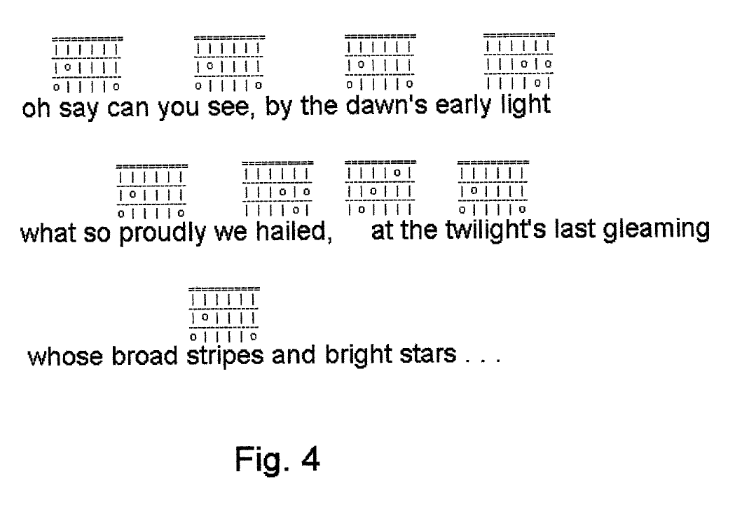

Many guitarists find tablature notation more convenient and accessible than more traditional treble/bass clef musical notation having a key signature. Also, guitarists and those they accompany are often familiar with the lyrics, melody, and time-signature of a composition, but need support in coordinating the chord patterns and timing with these familiar elements. In these instances, guitar tablature acts as a simple yet powerful transcription tool for representing music, with substantially less burden of complexity on the transcriber than with the traditional treble/bass clef musical notation. Where it can be assumed that the reader is familiar with the lyrics and melody of a composition, as is often the case, the transcriber is free to first transcribe the lyrics of a composition, and then intersperse the tablature chord positions within these familiar lyrics. For example, FIG. 4 shows how the guitar tablature of the present invention can be incorporated within, above, or below composition lyrics, in whatever form the composer finds most readable. The composition shown is the “Star Spangled Banner”, chosen for its familiarity.

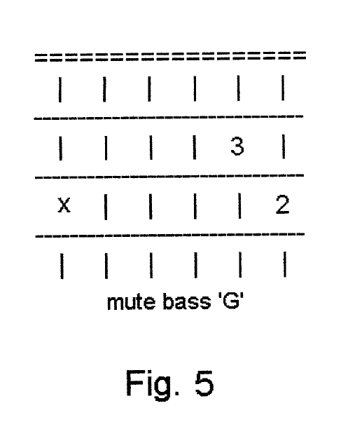

As should now be clear, anything representable in computer text can be incorporated into the tablature of the present invention. One such example would be a type of specialized “reminder note”, consisting of a brief message familiar to the composer or reader. FIG. 5 shows one example of just such a reminder note, labeling the tablature figure G (to symbolize a G major chord), but including the reminder “mute bass G”. Such a feature would be useful as an additional reminder, on top of the existing tablature, to not strike the lowest (bass) string where the note G is often sounded as part of a G chord.

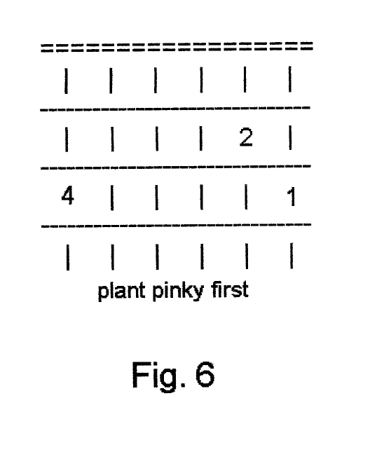

Another area such a feature would be useful is in reminding the reader how to properly finger the chord. FIG. 3 gave an example of how to position the specific fingers on the fretboard, but some guitarists also find it convenient to be reminded of which finger to plant, or anchor, first when reaching for a new chord position. Beginning a chord with the incorrect finger can sometimes lead to improper sounding, or perhaps no sounding, of a specific chord. Because of the speed at which music progresses, a guitarist may have ¼ or ⅛ of a second to complete one chord and move on to start another chord. Also, a composition may have as many as 25 or more different chord positions that need to be learned and mastered. Consequently, a musical reminder which could enhance the learning and fingering process is useful. FIG. 6 shows a tablature representation of a guitar chord using the present invention, wherein a reminder “anchor pinky first” appears beneath the tablature. In this instance, the annotation “anchor pinky first” means to plant the fourth finger of the fingering hand before applying either of the other fingers. Such a feature could be useful for an accomplished professional responsible for learning a large portfolio of songs. Similarly, a teacher or instructor aware of a student's propensity for a specific type of mistake can incorporate warnings or suggestions at specific points in a composition where a student has been having difficulty. Thus, the computer text tablature of the present invention could be useful for an accomplished professional as well as for a novice student.

As stated above, for readability a user of the present invention could include a notation underneath the guitar tablature which could read ‘G’ (for G major) or ‘Gm’ (for G minor) or ‘Gm7’ (for G minor 7th). One advantage of this is that a pianist can also play a composition transcribed using the present invention. This is assuming that the pianist can read and produce a G major, G minor, or G minor 7th chord on a piano without need for sheet music.

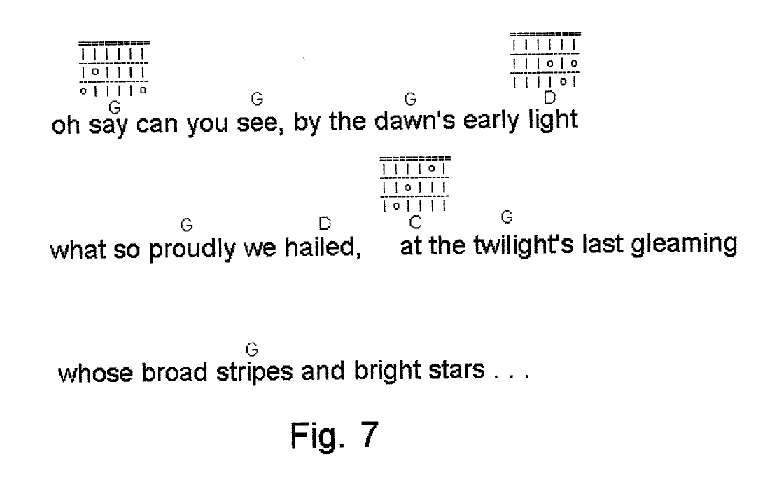

Additionally, in order to reduce clutter and enhance the visual flow of a piece of music transcribed using the present invention, a guitarist/transcriber could write out the tablature for G minor 7th, for example, during its first occurrence within a composition. Afterwards, however, the guitarist/transcriber could just repeat the characters Gm7, without having to copy and paste the entire tablature representation. This remains true as long as the guitarist/transcriber does not intend for the reader to play a G minor 7th in some other fretboard position. Also, the ability to incorporate a note or message to the reader can be especially useful, such as the exhortation to “mute bass G”. A guitarist accustomed to the traditional guitar chord positions could easily adapt to such an arrangement, and will appreciate any text notes to be aware of minor or even perhaps significant variations on a traditional chord. Although it is certainly true that tablature by itself is sufficient to render a composition properly, adding text hints can be helpful as a memory aid and learning tool. FIG. 7 shows the Star Spangled Banner of FIG. 4, modified to take advantage of this feature.

The computer text tablature of the present invention is also acceptable for inclusion within copyright applications such as the United States Library of Congress' form PA (Performing Arts), which requires that written version of a composition be submitted. However, this copyright feature has certain limitations. Such a feature would be best suited for guitarists who are interested obtaining copyright protection for guitar-only compositions, or guitar-only compositions and lyrics. It would not be useful for a composer interested in obtaining copyright protection for guitar chord positions, lyrics, and melody. This is because, as stated, the present invention is most useful for transcribing guitar positions into tablature. Although it is also useful for combining guitar tablature and lyrics, the scope of this invention does not encompass transcribing guitar tablature, lyrics, and melody.

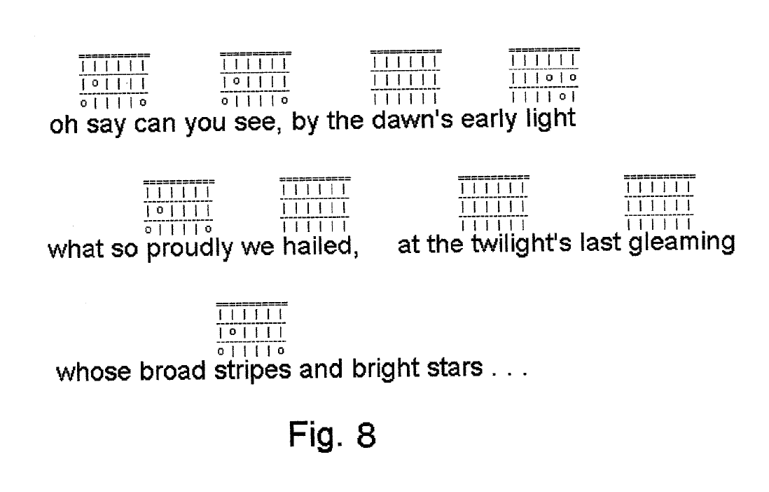

A guitarist/transcriber who is familiar with the words and is aware that a chord is to be struck at a particular point in the composition could also use the present invention to learn and transcribe a composition even where she has not yet determined the specific chords. This would be accomplished by, as described, first transcribing the words to a composition and typing them into a word processor. The guitarist/transcriber could then place blank, unpopulated templates (such as template 100 shown in FIG. 1) at the location in the composition where a chord is struck. The user could then learn the specific chords corresponding to where the blank tablature template was located, and fill in or populate the chord tablature pattern whenever she eventually deciphers the chord. The user could populate the chords in pencil and later enter them into the word processor, or the user could enter them directly into the word processor. Either way, a means for learning and retaining a complicated composition can be realized. Also, because of the ability to place blank templates with the idea of populating them afterwards, the user can learn and transcribe a composition in intermediate sections as is convenient, secure in the knowledge that their draft progress can be saved. FIG. 8 shows a representation of an intermediate, not-fully-populated draft, again using the “Star Spangled Banner” as a prototype composition.

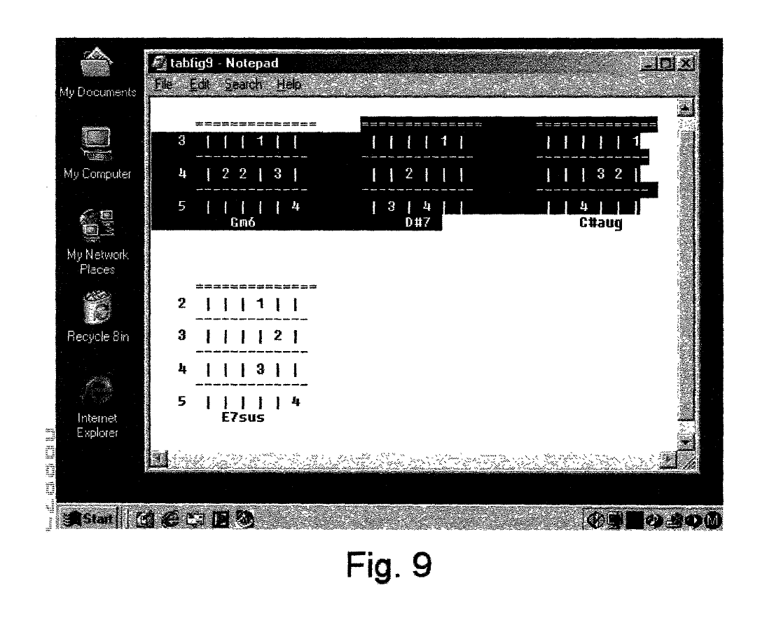

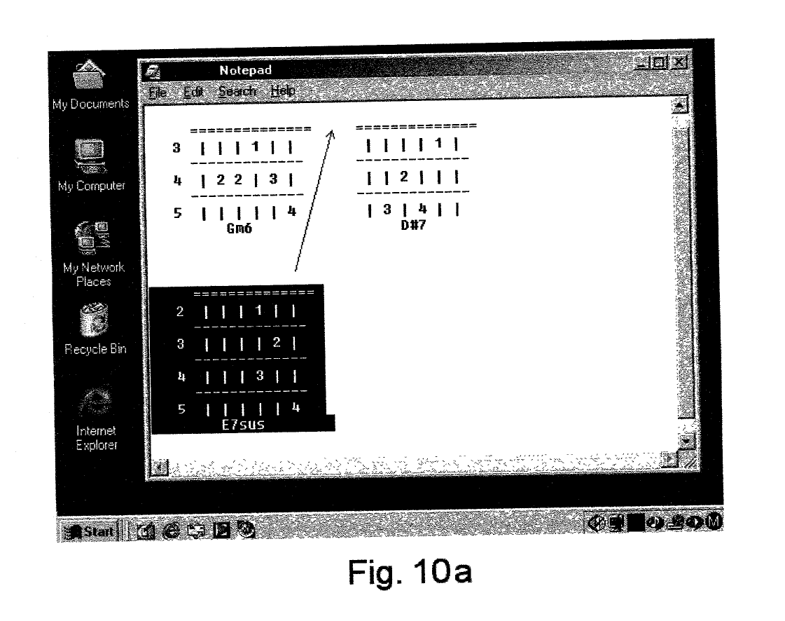

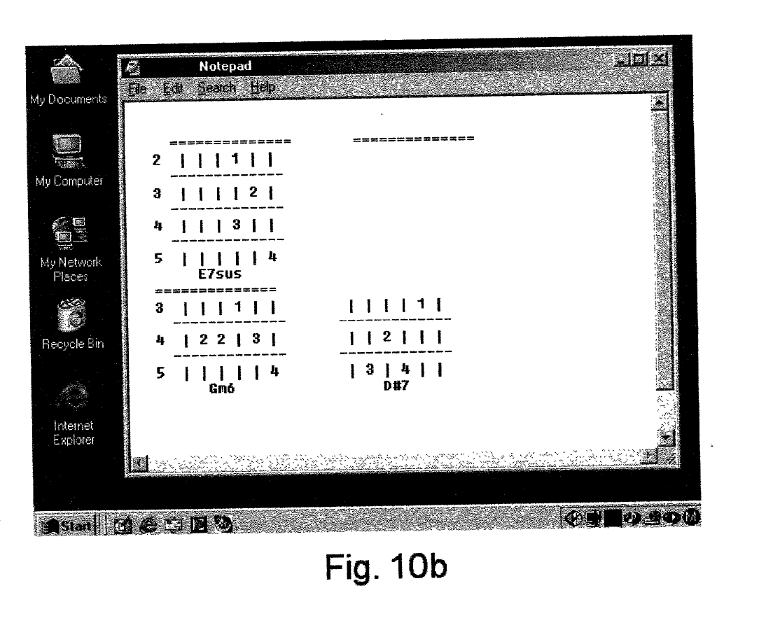

One limitation of the present invention is that many simple text editors can only copy/select/cut text line by line. This can be a disadvantage if several tablature blocks are arranged horizontally, as is often the case. It then becomes difficult to select just one of the tablature blocks for copying/cutting, as shown in FIG. 9, because the highlight/select box is linear (that is, runs continuously with textflow). Thus, it is impossible to copy only the D#7 tablature block without also copying portions of the Gm6 and C#aug tablature blocks shown in FIG. 9. Even in the case where two tablature blocks are positioned vertically, and thus can be separately highlighted/selected/copied as shown by the E7sus block in FIG. 10a, many text editors lack the ability to paste the selected tablature horizontally. Attempts to do so result in breaking or corrupting of the non-pasted tablature blocks. FIG. 10b. shows one example of this problem, where an attempt to paste an E7sus tablature block between Gm6 and D#7 tablature blocks (see FIG. 10a) results in the corrupting of both the Gm6 and D#7 tablature blocks.

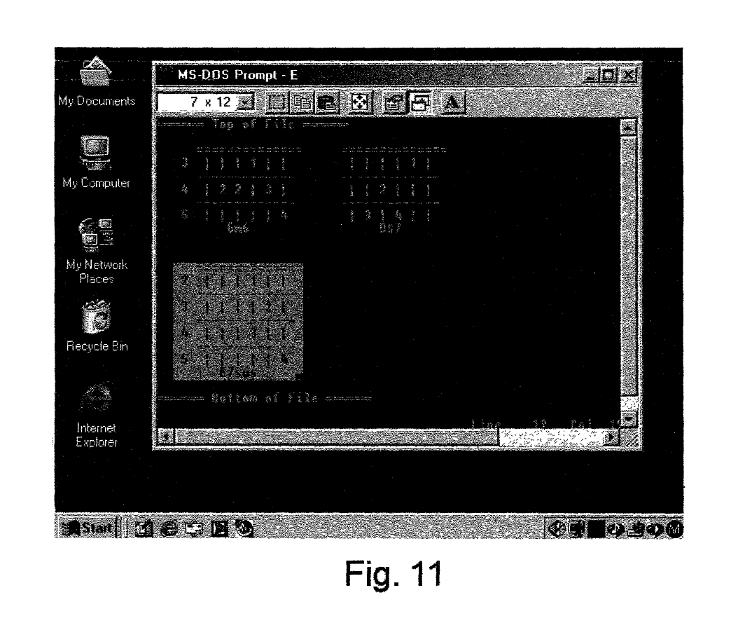

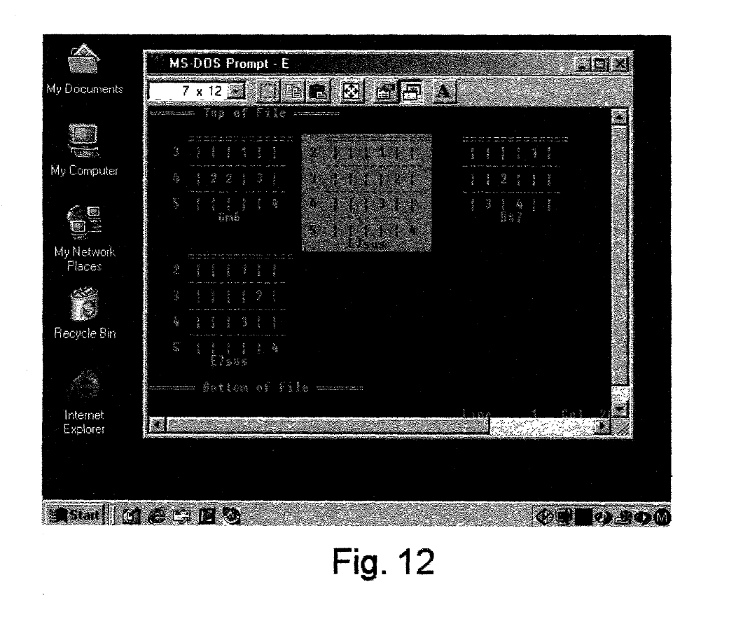

More complex text editors, however, support selecting/copying/cutting nonlinear blocks of text. An example of such an editor is shown cutting/copying the E7sus tablature block in FIG. 11, and in FIG. 12, pasting that same block of tablature to be horizontally adjacent to both the Gm6 and D#7 tablature blocks, without corrupting either.

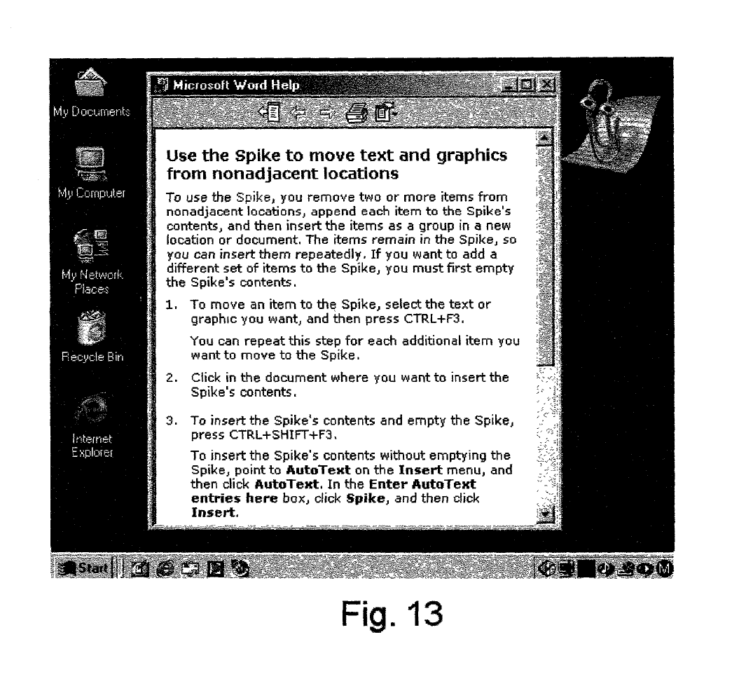

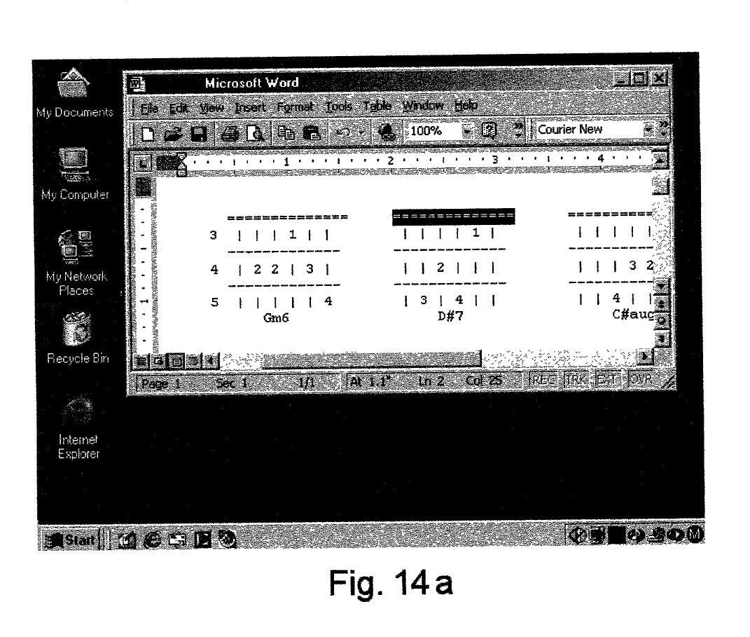

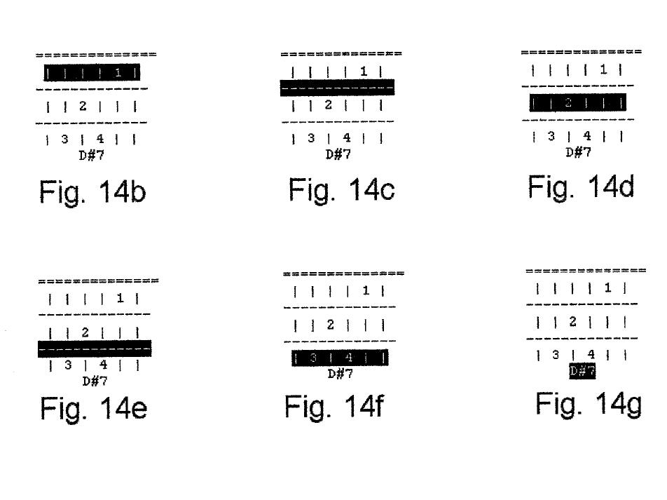

Similarly, Microsoft Word has a “spike” feature which support of the copying of groups of non-sequential blocks of text, as shown in FIG. 13. The “spike” feature allows for the cutting/copying of a single block of tablature even when positioned within a horizontal group of tablature symbols, by cutting the block line-by-line as shown in FIGS. 14a-i.

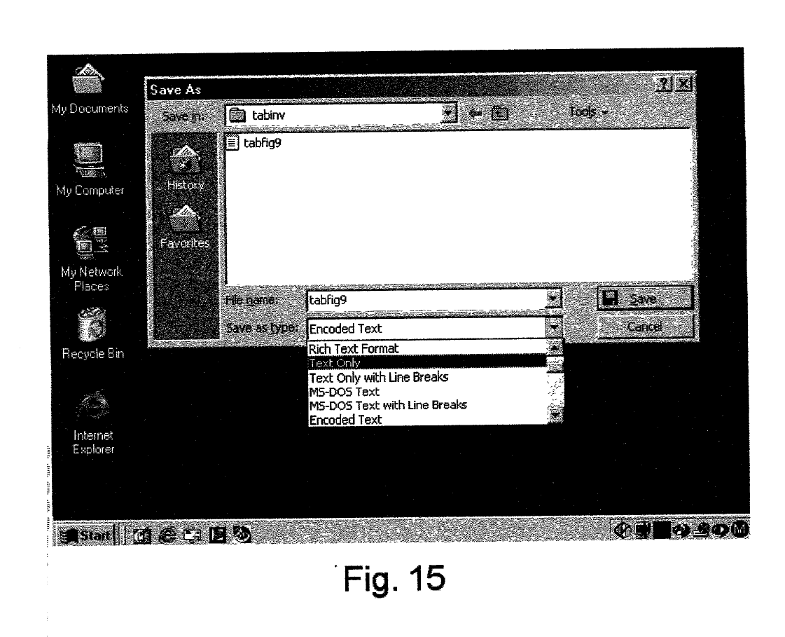

It is worthwhile to note that text files created with such advanced features could still be read by the standard ASCII text editor available on any computer. However, if Microsoft Word were used for editing, the user must be aware of the necessity to save the file in “text only”, or “text with line breaks” (either MS-DOS or not), as shown in FIG. 15. Even were the user to forget this step, and save the file as a Microsoft Word file, any other user of the document would still be able to read the file as long as they had access to Microsoft Word.

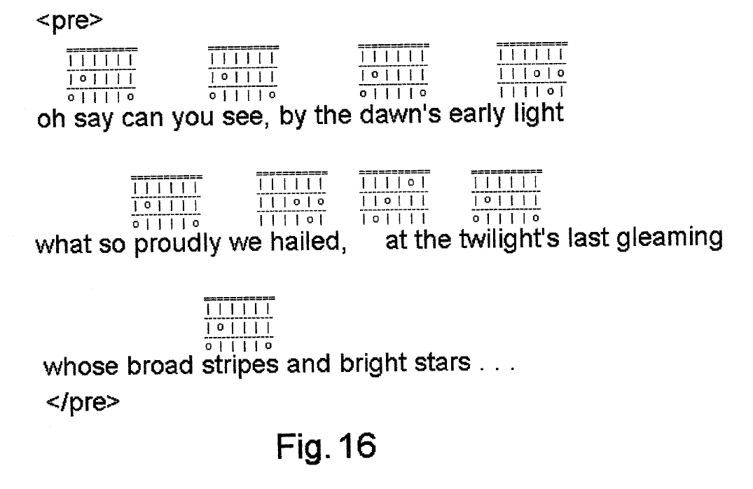

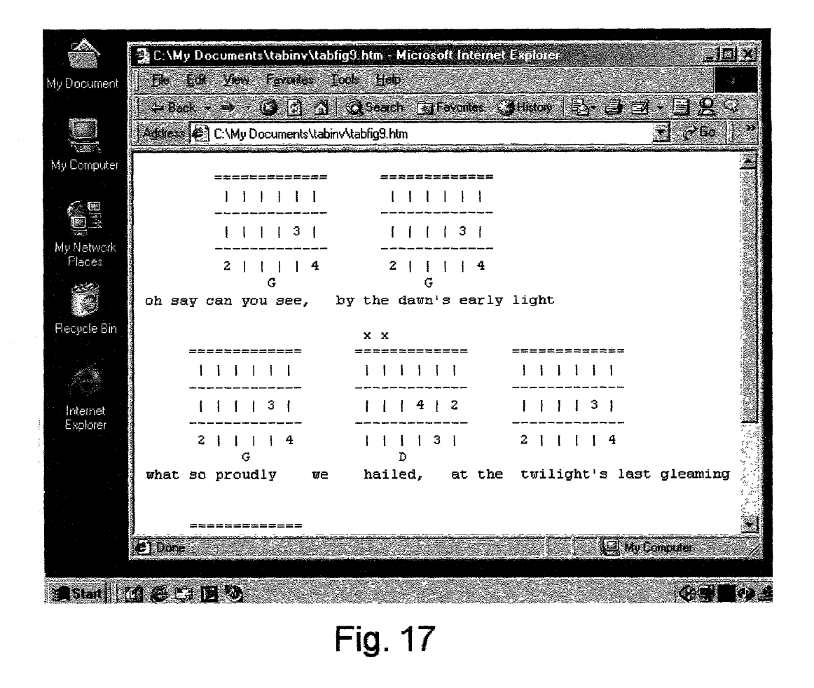

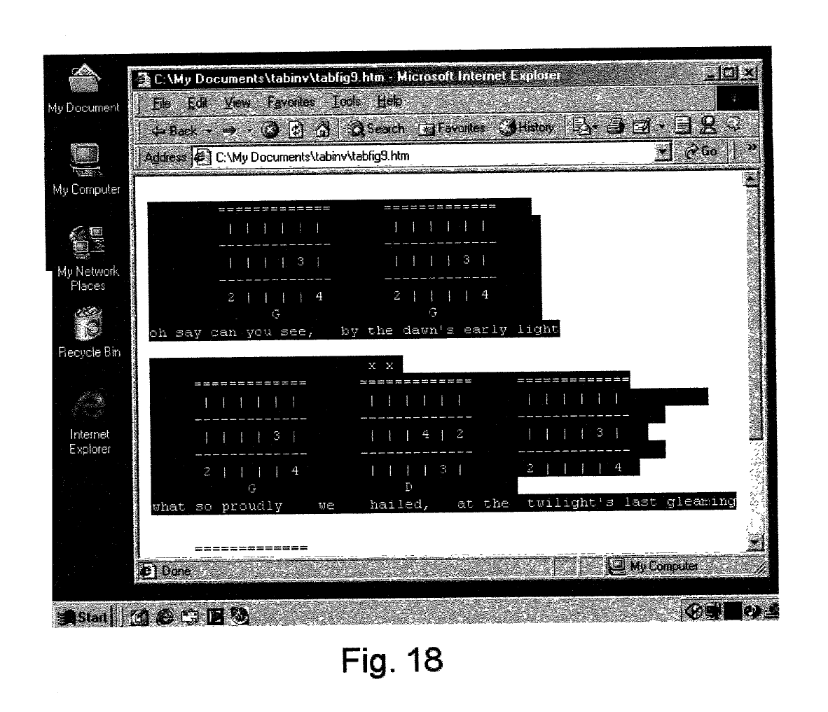

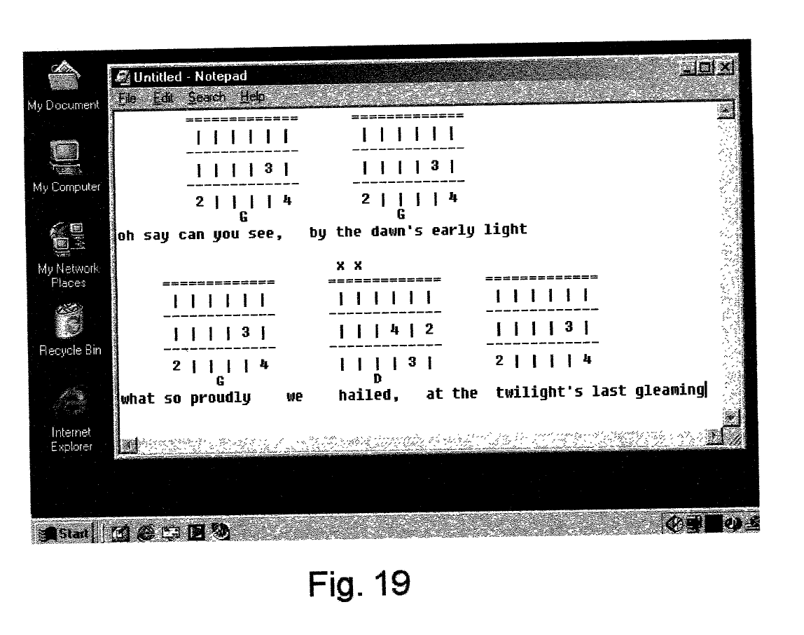

In regard to the Internet, the guitar tablature of the present invention can easily be rendered into .html for displaying on a website, with all spacing and typesetting preserved. This is accomplished by use of the .html <pre> tag, which preserves the text formatting and spacing of the original document. The rendering of the “Star Spangled Banner” of FIG. 4 is shown with the .html <pre> (open pre-formatting) and </pre> (close pre-formatting) tags in FIG. 16. FIG. 17 shows what this text then would look like when viewed over the Internet through the Microsoft Internet Explorer browser. FIGS. 18 and 19 show how a remote user could copy and download a pristine, text-only non-.html version of composition uploaded using the present invention, with all formatting and spacing preserved. Such a user would not need to know any .html in order to copy, save, and e-mail compositions. The user would only need to know, within Internet Explorer, how to highlight the desired text and use control-C, and then use control-V in Notepad. Also, as stated earlier, such text-only files created thus have a very small file size. Thus, the composition files could be remotely downloaded very quickly, including by multiple users such as in a band or orchestra, for example. In FIG. 19., although Microsoft Notepad is shown, any text editor on any computer could accomplish the same purpose. This reinforces the assertion that the computer text guitar tablature of the present invention can be useful to any skill level, from novice to professional, requiring only that the user have a passing familiarity with computers.

Conversely, tablature images created with proprietary software packages might be uploadable to the World Wide Web, but the text contained within such files could not be downloaded, edited, or stored. This is because these files may have been uploaded as some type of image file, such as .pdf or .gif, and are therefore rendered into an image format and not a text format. While it is true such images could still be downloaded, printed, and exchanged, their content cannot be edited without considerable difficulty. Also, their image format precludes any possibility that the text characters contained therein could be extracted. A file created using the computer text guitar tablature of the present invention, on the other hand, is transportable and editable without significant difficulty. Also, the text-only nature of the present invention makes it eminently suitable for e-mail, either as an attachment or in the body of the message.

The preceding description has been presented only to illustrate and describe the invention. It is not intended to be exhaustive or to limit the invention to any precise form disclosed. Many modifications and variations are possible in light of the above teaching. The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A software implementation of guitar tablature, comprising:
a horizontal row of equal sign ‘=’ characters representing a nut of a guitar;
a first group of six vertical bar ‘|’ characters located directly underneath said horizontal row of equal sign ‘=’ characters, representing the six strings of a guitar;
a first horizontal row of dash ‘-’ characters located directly underneath said first group of six vertical bar ‘|’ characters representing a first fret of a guitar, so that said first group of vertical bar characters then represent a first fretboard position on guitar;
a second group of six vertical bar ‘|’ characters located directly underneath said first horizontal row of dash ‘-’ characters, thereby representing a further extension of said six strings of a guitar;
a second horizontal row of dash ‘-’ characters representing a second fret of a guitar and located directly underneath said second group of six vertical bar ‘|’ characters, so that said second group of six vertical bar characters then represent a second fretboard position on guitar;
a third group of six vertical bar ‘|’ characters located directly underneath said second horizontal row of dash ‘-’ characters, thereby representing a further extension of said six strings of a guitar;
a third horizontal row of dash ‘-’ characters representing a third fret of a guitar and located directly underneath said third group of six vertical bar ‘|’ characters, so that said third group of six vertical bar characters then represent a third fretboard position on guitar;
a fourth group of six vertical bar ‘|’ characters located directly underneath said horizontal row of dash ‘-’ characters, thereby again representing a further extension of said six strings of a guitar;
a fourth horizontal row of dash ‘-’ characters representing a fourth fret of a guitar and located directly underneath said third group of six vertical bar ‘|’ characters, so that said fourth group of six vertical bar characters then represent a fourth fretboard position on guitar;
whereby predetermined of the vertical bar ‘|’ characters are replaced by either an ‘o’ (for nonspecific fingering) or ‘1’, ‘2’, ‘3’, ‘4’, or ‘T’, which correspond to the first, second, third, fourth fingers and thumb of the fretting hand according to a predetermined chord fingering; and
further whereby an ‘o’ or ‘x’ is optionally positioned above said horizontal row of ‘=’ signs to signify whether to strike or not strike a particular string, thereby achieving a computerized text only representation of a guitar chord tablature which can be cut, pasted, and saved.

2. The software tablature implementation of claim 1, further comprising:
composition lyrics written in plain computer text; whereby
a plurality of said computerized representations of guitar chord tablature blocks are located within, above, and below said composition lyrics; so that
a lyrics and tablature representation of an entire musical composition is achieved in plain computer text.

3. The software tablature implementation of claim 1, whereby the number of fretboard positions represented by computer text tablature ranges between one and five.

4. The software tablature implementation of claim 1, further comprising:
text characters ‘h’, ‘p’, ‘b’, ‘t’, ‘/’, ‘\’, ‘v’, ‘t’, or ‘x’ could also vertical bar ‘|’ characters, according to predetermined chord fingerings.

5. The software tablature implementation of claim 1, further comprising:
a plurality of user-customizable text notes, incorporated above, alongside, or underneath said tablature blocks.

6. The software tablature implementation of claim 5, wherein said user-customizable text notes further comprise chord letters, so that a pianist can render a recognizable version of the composition on a piano without needing the decipher the tablature block.

7. The software tablature implementation of claim 5, wherein said user-customizable notes further comprise a fingering suggestion, so as to remind a guitarist of an optimum method for reaching a specific fingering.

8. The software tablature implementation of claim 6, further comprising:
said chord letters appearing with tablature at a first occurrence within a composition, but at later occurrences appearing as chord letters/numbers only.

9. The software tablature implementation of claim 2, whereby said computerized representation is suitable without modification to apply for copyright protection.

10. The software tablature implementation of claim 2, further comprising:
an .html formatting symbol <pre>, located above all musical notation;
an .html formatting symbol </pre>, located below all musical notation, thereby rendering the entire composition into a form uploadable to the World Wide Web without further modification, while still preserving all formatting and spacing information necessary to read the composition.

11. The software tablature implementation of claim 5, whereby multiple users download said composition using the World Wide Web as distribution mechanism.

12. The software tablature implementation of claim 5, whereby multiple users receive and send said composition using e-mail as distribution mechanism, either as an attachment or in the body.

13. The software tablature implementation of claim 2, further comprising:
a plurality of said computerized representations of guitar chord tablature being located within said lyrics yet unpopulated with specific chord information, pending the completion of composing/transcribing process.

14. A method for implementing guitar tablature in computer software, comprising:
positioning a horizontal row of equal sign ‘=’ characters in the top line of a text-only computer file;
positioning a first group of six vertical bar ‘|’ characters directly underneath said horizontal row of equal sign ‘=’ characters;
positioning a first horizontal row of dash ‘-’ characters directly underneath said first group of six vertical bar ‘|’ characters;
positioning a second group of six vertical bar ‘|’ characters directly underneath said first horizontal row of dash ‘-’ characters;
positioning a second horizontal row of dash ‘-’ characters directly underneath said second group of vertical bar ‘|’ characters;
positioning a third group of six vertical bar ‘|’ characters directly underneath said second horizontal row of dash ‘-’ characters;
positioning a third horizontal row of dash ‘-’ characters directly underneath said third group of vertical bar ‘|’ characters;
positioning a fourth group of six vertical bar ‘|’ characters directly underneath said third horizontal row of dash ‘-’ characters;
positioning a fourth horizontal row of dash ‘-’ characters directly underneath said fourth group of vertical bar ‘|’ characters; then
replacing predetermined vertical bar ‘|’ characters with either an ‘o’ (for nonspecific fingering) or ‘1’, ‘2’, ‘3’, ‘4’, or ‘T’, which correspond to the first, second, third, fourth fingers and thumb of the fretting hand according to a predetermined chord fingering,
optionally positioning an ‘o’ or ‘x’ above said horizontal row of ‘=’ signs to signify whether to strike or not strike a particular string, thereby
achieving a representation of a predetermined guitar chord tablature in plain computer text which can be cut, pasted, and saved.

15. The method for implementing guitar tablature of claim 14, further comprising:
prior to said step of positioning a horizontal row of equal sign ‘=’ characters, transcribing lyrics of a composition into computer text; then
incorporating a plurality of said computer text guitar chord tablature representations within said lyrics of said composition.

16. The method for implementing guitar tablature of claim 14, further comprising:
varying the number of fretboard positions to vary between one and five.

17. The method for implementing guitar tablature of claim 14, further comprising:
replacing text characters ‘h’, ‘p’, ‘b’, ‘t’, ‘/’, ‘\’, ‘v’, ‘t’, or ‘x’ predetermined of the vertical bar ‘|’ characters, according to predetermined chord fingerings.

18. The method for implementing guitar tablature of claim 14, further comprising:
incorporating user-customizable text notes above, alongside, or underneath said tablature blocks.

19. The method for implementing guitar tablature of claim 18, further comprising:
representing chord letters within said user-customizable text notes, thereby
rendering said composition recognizable and playable to a pianist unfamiliar with guitar tablature.

20. The method for implementing guitar tablature of claim 18, further comprising:
representing fingering suggestions within said user-customizable text notes, thereby
reminding a user of an optimum method for reaching a specific fingering.

21. The method for implementing guitar tablature of claim 20, further comprising:
using said reminding step in the process of guitar instruction.

22. The method for implementing guitar tablature of claim 19, further comprising:
combining said chord letters with said tablature at a first occurrence within a composition, afterwards
rendering said tablature chord information as chord letters/numbers only.

23. The method for implementing guitar tablature of claim 15, further comprising:
utilizing said computer text guitar chord tablature representations within said lyrics, without modification, within a United States copyright application.

24. The method for implementing guitar tablature of claim 15, further comprising:
locating an .html formatting symbol <pre> above all musical notation of a composition;
locating an .html formatting symbol </pre> below all musical notation of said composition; then
uploading, without modification, said composition to the World Wide Web; while
preserving all formatting and spacing information necessary to read said composition.

25. The method for implementing guitar tablature of claim 24, further comprising:
downloading, by a plurality of users, said composition;
utilizing World Wide Web as distribution channel for said step of downloading.

26. The method for implementing guitar tablature of claim 24, further comprising:
distributing said composition to a plurality of users;
utilizing e-mail as distribution mechanism;
incorporating said composition as an attachment; or
incorporating said composition in the body of said e-mail.

27. The method for implementing guitar tablature of claim 15, further comprising:
locating a plurality of blank unpopulated computerized guitar tablature blocks within said lyrics; prior to
completing a composing/transcribing process.

28. The method for implementing guitar tablature of claim 27, wherein said completing step further comprises:
populating said blank tablature blocks directly into said computer; or
populating said blank tablature blocks with a pencil; then
updating said penciled tablature blocks into said computer.

28. The method for implementing guitar tablature of claim 15, further comprising:
selecting one of said guitar tablature blocks positioned within a horizontal row of a plurality of said tablature blocks without selecting any portion of any adjacent tablature block within said horizontal row of tablature blocks.

29. The method for implementing guitar tablature of claim 28, further comprising:
pasting said selected guitar tablature block within a horizontal row of a plurality of said tablature blocks without disturbing any portion of any adjacent tablature block within said horizontal row of tablature blocks.

30. The method for implementing guitar tablature of claim 28, further comprising:
said selecting step occurs using the Microsoft Word spike command.
